(19) United States
(12) Patent Application Publication
(10) Pub. No.: US 2024/0409472 A1
(43) Pub. Date: Dec. 12, 2024

(54) CERAMIC CORE-SHELL PARTICLES, METHODS OF MAKING SAME, AND CERAMIC ARTICLES MADE THEREFROM

(71) Applicant: CORNING INCORPORATED, CORNING, NY (US)

(72) Inventors: Monika Backhaus-Ricoult, Bourron (FR); Linda Kay Bohart, Liberty, PA (US); Kimberley Louise Work, Painted Post, NY (US)

(21) Appl. No.: 18/734,597

(22) Filed: Jun. 5, 2024

Related U.S. Application Data
(60) Provisional application No. 63/471,333, filed on Jun. 6, 2023.

(51) Int. Cl. C04B 38/00; C04B 35/628; C04B 41/00

(52) U.S. Cl. CPC C04B 38/0016; C04B 35/62886; C04B 35/62897; C04B 38/0054; C04B 38/0074; C04B 41/0072; C04B 2235/6021; C04B 2235/9607

(57) ABSTRACT

Embodiments of the disclosure relate to a sintered ceramic article. The sintered ceramic article includes sintered ceramic particles. The sintered ceramic particles include a shell at least partially surrounding at least one core. The shell is made from a first ceramic phase, and the at least one core is made from a second ceramic phase. The first ceramic phase differs from the second ceramic phase in at least one of density, composition, or pore morphology.

### CROSS-REFERENCE TO RELATED APPLICATIONS

This application claims the benefit of priority under 35 U.S.C. § 119 of U.S. Provisional Application No. 63/471,333 filed Jun. 6, 2023, the content of which is incorporated herein by reference in its entirety.

### BACKGROUND

The disclosure relates to ceramic particles used in sintered ceramic articles, and in particular, to ceramic particles having a core and shell structure used for forming, e.g., honeycomb structures.

For certain high-temperature operations, ceramic filters may be used to clean gaseous byproducts. For example, ceramic filters may be used as diesel particulate filters or gas particulate filters to remove particulates from exhaust gas. The ceramic filters are advantageous because they are able to operate at temperatures of greater than 1000° C. while also resisting thermal shock caused by rapid heating from extremely cold ambient temperatures.

### SUMMARY

According to an aspect, embodiments of the disclosure relate to a sintered ceramic article. The sintered ceramic article includes sintered ceramic particles. The sintered ceramic particles include a shell at least partially surrounding at least one core. The at least one core is made from a first ceramic phase, and the shell is made from a second ceramic phase. The first ceramic phase differs from the second ceramic phase in at least one of density, composition, or pore morphology.

According to another aspect, embodiments of the disclosure relate to a method. In the method, a paste including ceramic particles is extruded to form a green structure. The ceramic particles have a shell at least partially surrounding at least one core. The at least one core is made from a first ceramic phase, and the shell is made from a second ceramic phase. The first ceramic phase differs from the second ceramic phase in at least one of density, composition, or pore morphology. Further, in the method, the green structure is fired to sinter the ceramic particles into a sintered ceramic article.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1A-1J depict various types of ceramic particles having one or more cores surrounded by a shell, according to exemplary embodiments;

FIG. 2 is a flow diagram of a method for forming a ceramic particle, according to an exemplary embodiment;

FIG. 3 depicts a sintered ceramic article made from the ceramic particles, according to an exemplary embodiment;

FIG. 4 is a flow diagram of a method for forming the sintered ceramic article, according to an exemplary embodiment;

FIG. 5 is a graph of the particle size distribution for core particles used to form the ceramic particles, according to an exemplary embodiment;

FIG. 6 includes SEM images of ceramic particles after calcining, according to an exemplary embodiment;

FIG. 7 includes SEM cross-sectional images of some of the particles of FIG. 6 showing the core/shell structure, according to an exemplary embodiment;

FIG. 8 is a graph of particle size distribution for the ceramic particles after calcining, according to an exemplary embodiment; and

FIG. 9 are SEM micrographs of a wall of a honeycomb structure extruded from core/shell ceramic particles, according to an exemplary embodiment.

### DETAILED DESCRIPTION

Reference will now be made in detail to various embodiments of a sintered ceramic article formed from ceramic particles having one or more cores surrounded by a shell. According to the present disclosure, cores of a first ceramic phase are surrounded by a shell of a second ceramic phase in which the first and second ceramic phases differ in at least one of density, composition, or pore morphology. Sintered ceramic articles formed of such particles provide several advantages. For instance, the shells of the ceramic particles can be selected to provide a highly porous yet strong structural backbone with the cores of the ceramic particles being selected to provide a specific chemical, catalytic, or physical function. Further, in experimental embodiments of honeycomb structures formed from cordierite and mullite core/shell ceramic particles, it was found that the modulus of rupture was significantly higher than for honeycomb structures formed through conventional methods and particles. These and other aspects and advantages of the sintered ceramic articles formed from core/shell particles will be described in relation to the embodiments provided below and depicted in the figures. These embodiments are presented by way of illustration and not by way of limitation.

Conventional sintered ceramic articles formed into honeycomb shapes can have a wide variety of cell geometries and provide highly interconnected porosity with generally sphere-shaped pores. Typically, such sintered ceramic articles are formed from extruded batches of reactive raw materials that react upon sintering. For example, a cordierite or mullite honeycomb structure may be formed by extruding a paste containing particles of raw materials that form cordierite or mullite, and upon firing the extrusion, the raw materials react to form a final structure of cordierite or mullite. The surface area provided by the honeycomb structure is based in part on the honeycomb cell structure and also in part on the porosity of the honeycomb walls. In this regard, increasing the porosity of the honeycomb walls, increasing cell density, and/or decreasing wall thickness increases the available surface area; however, the surface area achievable through such modifications in the honeycomb structure is limited because these modifications rapidly degrade the material strength below acceptable standards.

Thus, according to embodiments of the present disclosure, the honeycomb structure is formed using pre-reacted ceramic particles having a core/shell structure that allows for strong particle-to-particle interlinks, increasing the strength of honeycomb walls. In this way, greater increases in porosity, greater decreases in wall thickness, and greater increases in cell density are possible, leading to more available surface area in the honeycomb structure. Additionally, by using a core/shell structure, the honeycomb structure can be multifunctional based on the selection of the materials for the core and shell. For example, using two different ceramic materials for the core and shell allows for the possibility of providing multiple types of chemical or catalytic reaction sites, which may allow for multistep catalytic, sorption, or desorption reactions.

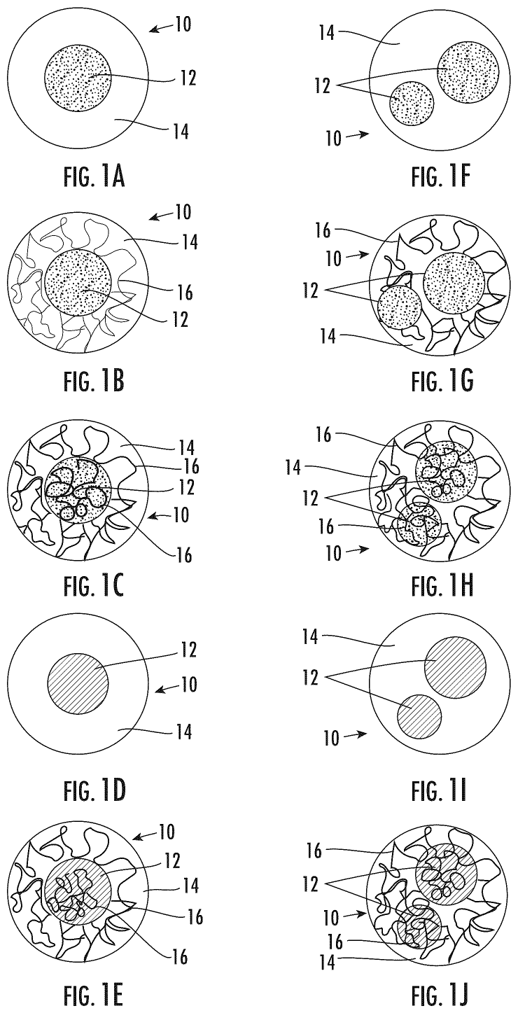

FIGS. 1A-1J depict example embodiments of ceramic particles 10 according to the present disclosure. In general, each ceramic particle 10 includes at least one core 12 and a shell 14 at least partially surrounding each core 12. The morphology of the core 12 and shell 14 can vary widely depending on the particular use of the article formed by the ceramic particles 10.

In FIG. 1A, the ceramic particle 10 includes a core 12 of a first ceramic phase and a shell 14 of a second ceramic phase. The first ceramic phase of the core 12 and the second ceramic phase of the shell 14 differ in at least one of composition, density, or pore morphology. A difference in composition means, for example, that the first ceramic phase has a different chemical formula or chemical structure than the second ceramic phase. A difference in density means, for example, that the first ceramic phase is more or less porous than the second ceramic phase, and a difference in pore morphology means, for example, that the first ceramic phase has pores of a different size or shape than pores of the second ceramic phase. In FIG. 1A, the core 12 and the shell 14 have the same composition and pore morphology but differ in density.

In FIG. 1B, the ceramic particle 10 includes a core 12 of a first ceramic phase and a shell 14 of a second ceramic phase in which the first ceramic phase and the second ceramic phase have the same composition but different pore morphologies. In particular, the core 12 is dense and the shell 14 has open, interconnected pores 16.

In FIG. 1C, the ceramic particle 10 includes a core 12 of a first ceramic phase and a shell 14 of a second ceramic phase in which the first ceramic phase and the second ceramic phase are the same material and have the same open, interconnected pore morphology. In FIG. 1C, the first ceramic phase of the core 12 differs from the second ceramic phase of the shell 14 in density.

In FIG. 1D, the ceramic particle 10 includes a core 12 of a first ceramic phase and a shell 14 of a second ceramic phase in which the first ceramic phase has a different composition than the second ceramic phase. In one or more embodiments, the first ceramic phase and the second ceramic phase may additionally differ in density and/or pore morphology.

In FIG. 1E, the ceramic particle 10 includes a core 12 of a first ceramic phase and a shell 14 of a second ceramic phase in which the first ceramic phase has a different composition from the second ceramic phase. However, both the core 12 and the shell 14 have open interconnected pores 16.

FIGS. 1F-1J relate to the embodiments of FIGS. 1A-1E with the exception that the embodiments of FIGS. 1F-1J include multiple cores 12. As shown in FIG. 1F, the ceramic particle 10 includes two cores 12 of a first ceramic phase and a shell 14 of a second ceramic phase. In the embodiment of FIG. 1F, the first ceramic phase and the second ceramic phase are the same material and have the same pore morphology but differ in density.

In FIG. 1G, the ceramic particle 10 includes two cores of a first ceramic phase and a shell 14 of a second ceramic phase in which the first ceramic phase and the second ceramic phase are the same material. In the embodiment of FIG. 1G, the first ceramic phase of the cores 12 differs in density and pore morphology from the second ceramic phase of the shell 14 with the second ceramic phase having open, interconnected pores 16.

In FIG. 1H, the ceramic particle 10 includes two cores 14 of a first ceramic phase and a shell 14 of a second ceramic phase in which the first ceramic phase and the second ceramic phase are the same material and have the same pore morphology of open, interconnected pores 16. In FIG. 1H, the first ceramic phase differs from the second ceramic phase in density.

In FIG. 1I, the ceramic particle 10 includes two cores 12 and a shell 14. In one or more embodiments, the two cores 12 may be made of the same phase or different phases, and the shell 14 may be the same phase as one of the cores 12 or a third phase different from the phases of both cores 12. In particular, in FIG. 1I, the phase of the shell 14 differs from the phase of at least one of the cores 12 in terms of composition. Additionally, the two cores 12 and the shell 14 may also differ in terms of density and pore morphology.

In FIG. 1J, the ceramic particle 10 includes two cores 12 and a shell 14 in which the cores 12 and shell 14 have phases of at least two different materials and in which at least one of the cores 12 as well as the shell 14 has open, interconnected pores 16.

The embodiments depicted in FIGS. 1A-1J are merely exemplary, and other combinations of core 12 and shell 14 may be possible. Additionally, while FIGS. 1F-1J, depict only two cores 12, other ceramic particles 10 may include more than two cores 12. Further, a powder comprising the ceramic particles 10 may include some ceramic particles 10 having only a single core 12 and some ceramic particles 10 having multiple cores 12. Further, in one or more embodiments, the ceramic particles 10 may be mixed with other particles that do not have a core/shell structure.

While the figures generally depict the cores 12 being entirely surrounded by the shell 14 (i.e., the shell 14 forms the entire outer surface of the ceramic particle 10), the shell 14 may only partially surround the core 12 or cores 12 such that one or more of the cores 12 forms at least a portion of the outer surface of the ceramic particle 10.

In one or more embodiments, the core 12 and shell 14 are made from ceramic materials. In one or more embodiments, suitable ceramic materials include cordierite, mullite, alumina, aluminum titanate, feldspar, and combinations thereof, among other possibilities.

In one or more embodiments, the ceramic particles 10 have a median pore size in a range 0.5 μm to 5 μm. The median pore size of the ceramic particles 10 refers to the pores within the ceramic particles 10 (intraparticle porosity), not the pores between the ceramic particles 10 (interparticle porosity).

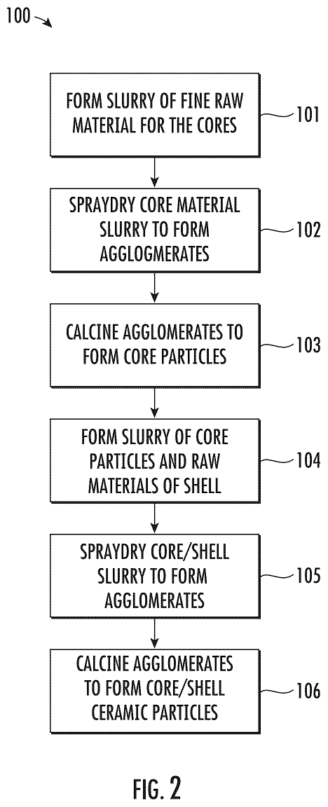

FIG. 2 depicts a flow diagram of a method 100 of forming the ceramic particles 10 according to the present disclosure. In the method, a first step 101 involves forming a slurry of fine raw material for the cores 12. The raw materials used in the slurry will depend on the ceramic material of the core 12. For example, for forming cordierite or mullite cores 12, the raw materials may be alumina-, magnesia-, and silica-based raw materials. In a second step 102, the slurry of raw materials is spraydried to form agglomerates of the raw materials.

Thereafter, in a third step 103, the raw material agglomerates are calcined and prereacted to form the cores 12. As used herein, to “calcine” is to thermally treat raw materials at a temperature (below melting temperature) and for a time to create a powder having a desired composition and physical properties, which may involve removal of volatile fractions and/or reactions between the raw materials. In one or more embodiments, calcining is performed at a temperature in a range from 1200° C. to 1500° C. for a time of 2 hours to 8 hours so as to react the raw materials to form the desired composition of the cores 12. The cores 12 may be any of a variety of sizes depending on the desired size of the final ceramic particle 10. In one or more embodiments, the cores 12 have a median size (D50) in a range from 10 μm to 30 μm, in particular from 10 μm to 20 μm. To produce cores 12 in this size range, the raw materials, in one or more embodiments, may have a median size (D50) in a range from 1 μm to 20 μm, in particular from 5 μm to 10 μm.

In a fourth step 104, a slurry is formed that contains the cores 12 as well as the raw materials for the shells 14. The raw materials used to form the shells 14 will also depend on the ceramic material of the shell 14. In one or more embodiments, the weight ratio of cores 12 to material for shells 14 is in a range from 0.5:1 to 2:1, in particular about 1:1. In a fifth step 105, the slurry of raw materials and cores 12 is spraydried to form agglomerates of cores 12 surrounded by the raw materials of the shell 14. In a sixth step 106, the agglomerates are calcined to form the ceramic particles 10. In one or more embodiments, calcining is performed at a temperature in a range from 1200° C. to 1500° C. for a time of 2 hours to 8 hours so as to react the raw materials to form the desired composition of the shells 14 around the cores 12. In one or more embodiments, the ceramic particles 10 have a median size (D50) in a range from 20 μm to 50 μm, in particular from 25 μm to 40 μm. Further, in one or more embodiments, the spraydried ceramic particles 10 have a span of particle size that is in a range of 0.8 to 1.4, in particular 0.9 to 1.2. As used herein, “span” is calculated according to the formula of ((D90-D10)/D50), in which 10% of the ceramic particles have a size below a first size (D10), 50% of the ceramic particles have a size below a second size (D50) (which is also the median particle size), and 90% of the ceramic particles 10 have a size below a third size (D90).

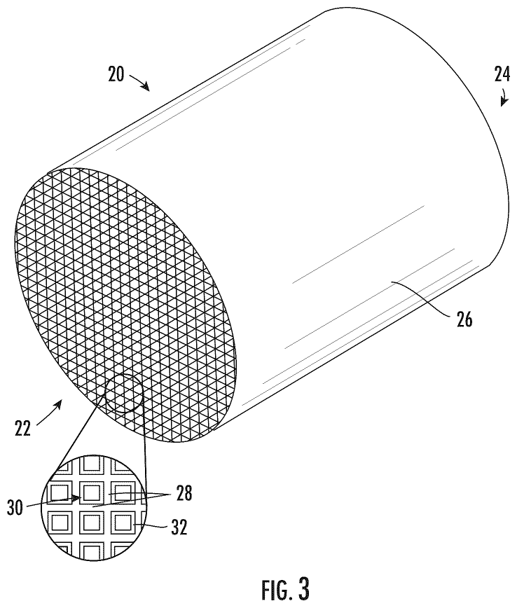

The ceramic particles 10 can be used to form a variety of different sintered ceramic articles. FIG. 3 depicts an example of a sintered ceramic article, in particular a honeycomb structure 20, that can be formed from the ceramic particles 10. As can be seen in FIG. 3, the honeycomb structure 20 has a first end face 22 and a second end face 24 connected by an outer wall 26. In the embodiment shown in FIG. 3, the first end face 22 and the second end face 24 are circular with the outer wall 26 extending substantially straight between the edges of the end faces 22, 24 to define a cylindrical body. However, in one or more other embodiments, the honeycomb structure 20 may have an elongated body with end faces 22, 24 of different shapes, such as various polygons or curved shapes.

Within the outer wall 26, the honeycomb structure 20 includes a plurality of intersecting walls 28 that define channels 30 extending from the first end face 22 to the second end face 24. While referred to as a “honeycomb” structure 20, it is not meant to imply that the intersecting walls 28 necessarily define hexagonal shape. Instead, the intersecting walls 28 may define a variety of different shapes, including hexagonal and quadrilateral shapes (such as a square), among others. In one or more embodiments, some or all of the channels 30 include a coating 32 applied to the intersecting walls 28. In such embodiments, the coating 32 may be used to enhance filtration, catalyze a reaction, or trap molecules. In one or more embodiments, the coating 32 can be applied through washcoating the honeycomb structure 20.

In one or more embodiments, the honeycomb structure 20 can be used in various contexts, such as in the automotive industry, in chemical engineering, for sorption processes, and for filtration processes, among other possibilities. In the automotive industry, honeycomb structures 20 may be used for CO and NOx abatement or as diesel and gasoline particulate filters. In chemical engineering, the honeycomb structure may be used as a catalyzed alumina or other substrate. In sorption processes, the honeycomb structure 20 can be used to capture carbon or other gases. In filtration processes, the honeycomb structure 20 can be used as an air filter, water filter, oil filter, or liquid metal filter. This list of examples for use of a honeycomb structure 20 is illustrative, and the honeycomb structure 20 may be used in other contexts besides those mentioned here.

According to a particular application, Applicant believes that the honeycomb structure 20 formed from the presently disclosed ceramic particles 10 is particularly suitable for carbon capture technology. In particular, the ceramic particles 10 allow for the formation of a honeycomb structure 20 that has a high porosity and low mass. Additionally, the multifunctional particles are customizable to enhance carbon capture. For example, the core 12 can be made of a carbon getter material. Alternatively or additionally, the core particles can be infiltrated with a carbon getter material during calcining of the green core particles. Thereafter, a shell 14 with open, interconnected pores can be formed around the getter core 12 to allow for the transport of carbon gases to the core 12.

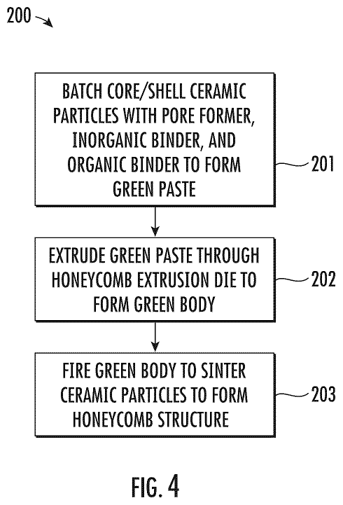

FIG. 4 depicts a flow diagram of a method 200 for forming a sintered ceramic article from the ceramic particles 10. In a first step 201 of the method 200, the ceramic particles 10 are batched with a pore former, an inorganic binder, and an organic binder to form a green paste. In a second step 202, the green paste is extruded through a honeycomb extrusion die and cut to length to produce a green body. In a third step 203, the green body is fired to sinter the ceramic particles 10 to produce the honeycomb structure 20. As used herein, to “sinter” is to thermally treat ceramic particles at a temperature (below melting temperature), (optionally) under a pressure, and for a time sufficient to fuse the ceramic particles and densify the green body, which may involve reactions between the ceramic particles and/or binder materials. Advantageously, as compared to conventional honeycomb structures, the honeycomb structure 20 according to the present disclosure can be fired at a lower temperature and for less time. In one or more embodiments, the honeycomb structure 20 is fired at a temperature of 1400° C. or less for 8 hours or less, e.g., firing at a temperature in a range from 1325° C. to 1380° C. for about 4 hours to about 8 hours, to sinter the ceramic particles 10.

In one or more embodiments, a sintered ceramic article produced according to the present disclosure from the disclosed ceramic particles 10 has a porosity of at least 40%, at least 45%, at least 50%, at least 55%, or at least 60%. In one or more embodiments, the sintered ceramic article has a porosity of up to 70%. In one or more embodiments, the median pore size of the sintered ceramic article is in a range of 1 μm to 10 μm, in particular 5 μm to 8 μm. An increased strength of the sintered ceramic article according to the present disclosure was observed as compared to conventional structures formed from reactive batches having a similar porosity. Applicants believe that the increased strength results from discontinuities in the microstructure at boundaries between cores 12 and shells 14, which leads to discontinuous propagation of cracks and enhanced crack branching, producing an increase in toughness.

The structure of the sintered ceramic article predominantly involved necking between the shells 14 of adjacent ceramic particles 10 such that the shells 14 largely served to interconnect the ceramic particles 10 and such that the cores 12 were not generally involved in joining the ceramic particles 10.

As mentioned above, the core/shell particle structure may provide a sintered ceramic article having a higher modulus of rupture. In one or more embodiments, the modulus of rupture is at least 250 psi (e.g., for codierite structures), at least 300 psi, at least 350 psi (e.g., for mullite-containing structures), at least 400 psi, or at least 450 psi. In one or more embodiments, the sintered ceramic article has a coefficient of thermal expansion (CTE) in a range from 10-40·10⁻⁷/K, in particular 15-35·10⁻⁷/K.

### Experimental Examples

Ceramic particles 10 and a sintered ceramic article 20 were prepared according to the methods described above.

For all of the slurries prepared, a spraydryer with a rotary atomizer (Production Minor, available from GEA Group Aktiengesellschaft) was used for spraydrying aqueous slurries at a throughput of 5 kg/h to 12 kg/h. A narrow particle size distribution was achieved by optimizing spraydryer settings (pressure, temperature, nozzle) and slurry parameters (raw materials, solid loading, binder, and dispersant levels). All slurries were prepared with a high shear inline mixer (Charles Ross & Son Company) with square-holed rotor stator. Water and dispersants (Duramax D3005 and Melflux 2651F) were loaded into the vessel first. The mixer was then set to 60 Hz and turned on so that water with dispersant was circulating through the rotorstator and back into the vessel. The dry raw materials were then added directly into the rotorstator via the feedcone. After all the dry materials were added, the mixer was turned off and the stirrer was started at a rate of 80-100 rpm. Binder (Duramax B1022) was then added directly to the vessel and the slurry stirred for 15 mins before spray drying was started. A rotation speed around 30000 rpm was used for the rotary atomizer of the spraydryer. The inlet temperature was set at 200° C., and the cyclone temperature was set at 98° C. Slurry feed rate was dependent on composition, but the feed rate typically ranged from about 3 kg/hr to about 7 kg/hr.

Slurries for forming the cores 12 were prepared first. Table 1 summarizes the compositions of the different spraydried slurries used to produce fine 20 μm green agglomerates at the cyclone outlet of the spraydryer for the cores 12.

TABLE 1
Composition for Spraydrying of Core Particles

| Batch Code | ADD | ADE | ADH | ADN |
|---|---|---|---|---|
| % Cordierite/% Mullite | 100/0 | 100/0 | 30/70 | 0/100 |
| Alumina (A152SG) | — | — | 34.77 | 38.1 |
| Alumina (A300) | 18.89 | — | — | — |
| Hydrated Alumina | 13.86 | 43.68 | — | 18.5 |
| (Hydral 710) | | | | |
| Talc | 15.4 | — | 15.47 | — |
| Magnesium Hydroxide | 12.01 | 16.35 | — | — |
| (Magshield UF) | | | | |
| Clay (EBF 93) | 10.27 | — | 49.76 | 36 |
| Silica (Imsil A8) | 29.57 | — | — | 7.4 |
| Silica Soot | — | 40.97 | — | — |
| Duramax B1022 | 5 | 5 | 3 | 3 |
| Duramax D3005 | 1 | 1 | 0.2 | 0.2 |
| Melflux 2651F | 0.2 | 0.2 | 0.2 | — |

As shown above, the cores 12 were either pure cordierite, pure mullite, or a 30% cordierite/70% mullite composite composition. The cores 12 were made from various raw materials in order to obtain various compositions and/or different levels of intraparticle porosity and median pore size. The core slurries were spraydried at solids loading of 20 vol %. The viscosities of the slurries were about 100 cP for ADD, ADE, and ADH and about 10 cP for ADN.

The spraydried green cores were tray fired in a bottom-loaded box kiln and sieved at 500 mesh. The core particles were fired at 1275° C. for 8 hours for the ADD and ADE cordierite compositions, at 1325° C. for 4 hours for ADH cordierite-mullite composite composition, and at 1400° C. for 8 hours for the ADN mullite composition.

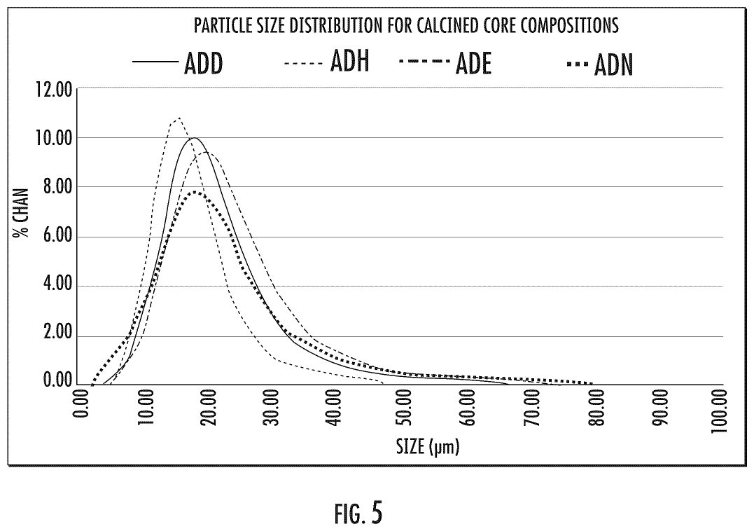

FIG. 5 is a graph of the particle size distribution for the core particles after calcining, and Table 2 summarizes the particle size distribution, including the D10, D50, D90, and span ((D90−D10)/D50). From FIG. 5, it can be seen that the cores 12 had a positive skew distribution with a median particle size D50 in a range from 14 μm to 19 μm.

TABLE 2
Particle Size Distribution for Core Particles

| | D10 | D50 | D90 | |
|---|---|---|---|---|
| Composition | (μm) | (μm) | (μm) | Span |
| ADD | 10.15 | 16.68 | 26.51 | 0.981 |
| ADE | 10.86 | 18.26 | 29.58 | 1.025 |
| ADH | 9.02 | 14.35 | 21.88 | 0.896 |
| ADN | 7.00 | 15.81 | 27.65 | 1.306 |

Next, a slurry of the shell composition was prepared. In each of the example embodiments, the shell was formed of porous cordierite. The slurry for the shell composition is provided below in Table 3.

TABLE 3
Composition for Spraydrying of Shell of Ceramic Particles

| Batch Code | AAG |
|---|---|
| % Cordierite/% Mullite | 100/0 |
| Magnesium Hydroxide | 19.35 |
| (Magshield UF) | |
| Clay (EBF 93) | 77.94 |
| Silica (Imsil A8) | 9.96 |
| Duramax B1022 | 3 |
| Duramax D3005 | 0.2 |
| Melflux 2651F | 0.2 |
| Water (wt %) | 15.0 |
| Solids Loading (vol %) | 20 |
| pH | 10.09 |
| Viscosity (mPas) | 277 |

Four slurries were formed, containing each of the four core particles mixed with the AAG shell composition. In the slurries, the solids were loaded at 20 vol % with the solids including 50 wt % of the core particles and 50 wt % of the shell composition as shown in Table 4, below. No difficulties were observed in spraydrying the core-shell particles, and spraydrying seemed similar to regular powders despite the presence of the core particles.

TABLE 4
Slurry Composition for Producing Core/Shell Particles

| Core/Shell | | |
|---|---|---|
| Particle | Core | Shell |
| AEI | ADH | AAG |
| AEJ | ADN | AAG |
| AEK | ADD | AAG |
| AEL | ADE | AAG |

The green core/shell particles were calcined at two different temperatures to produce ceramic particles 10 according to the present disclosure. Table 5, below, provides the temperature and time for calcining, the particle size distribution, and porosity of the particles.

TABLE 5
Ceramic Particle Properties

| | Calcining | | | | Porosity (Intraparticle) | |
|---|---|---|---|---|---|---|
| | Temp (° C.) | PSD | | | Particle | Particle |
| Ceramic | and Time | D10 | D50 | D90 | porosity | pore size |
| Particle | (h) | (μm) | (μm) | (μm) | (%) | (μm) |
| AEI | 1325° C./4 h | 10.42 | 25.94 | 44.38 | 43.47 | 1.02 |
| AEI | 1380° C./8 h | 19.32 | 29.32 | 44.86 | 39.18 | 1.48 |
| AEJ | 1350° C./4 h | 15.12 | 32.15 | 55.15 | 46.73 | 1.48 |
| AEJ | 1380° C./8 h | 19.27 | 32.96 | 53.86 | 47.41 | 1.83 |
| AEK | 1275° C./8 h | 14.38 | 26.47 | 43.38 | 43.73 | 1.08 |
| AEK | 1380° C./8 h | 19.97 | 34.78 | 58.79 | 34.02 | 2.44 |
| AEL | 1275° C./8 h | 16.05 | 26.35 | 41.9 | 41.67 | 0.82 |
| AEL | 1380° C./8 h | 20.73 | 30.51 | 46.37 | 31.63 | 2.29 |

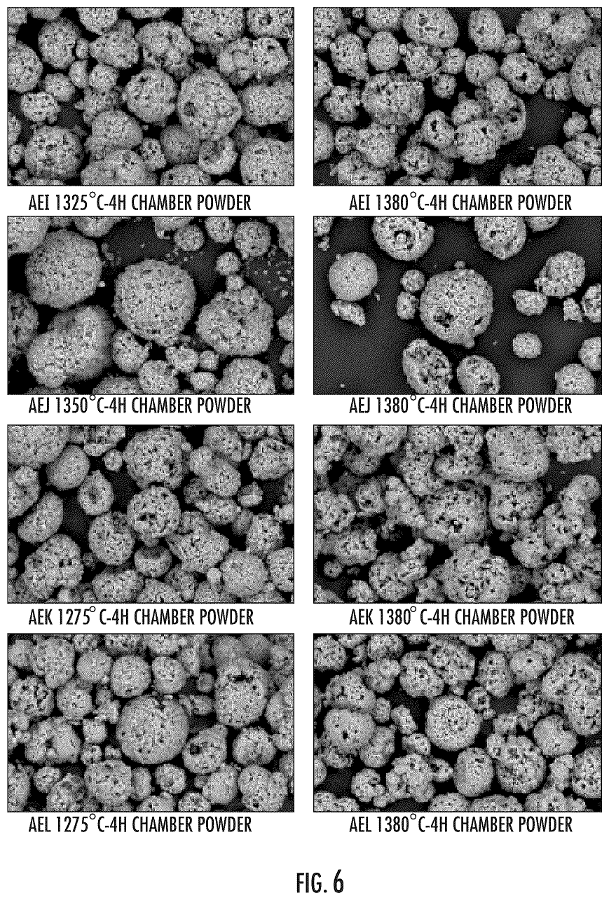

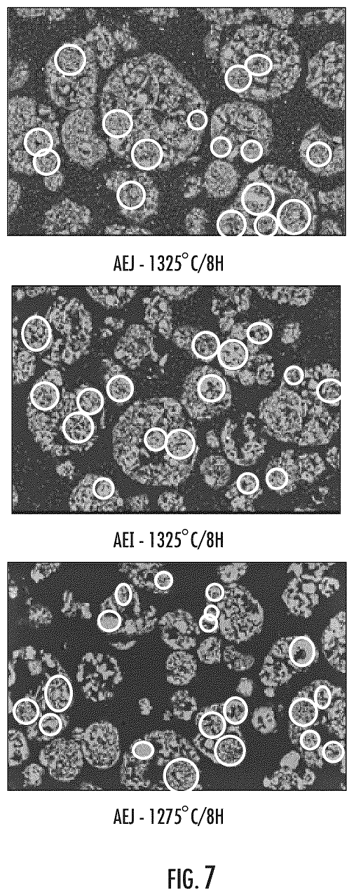

FIG. 6 depicts SEM images taken from each batch of the ceramic particles of Table 5. As can be seen in FIG. 6, the ceramic particles had very similar median particle size, were generally spherical, and highly porous. From Table 5, it can be seen that the particle porosity decreased with increasing calcining temperature, but median pore size increased with increasing temperature. FIG. 7 shows cross-sectional views of certain ceramic particles to highlight the core/shell morphology. In FIG. 7, the cores can be distinguished from the shells by their limited, small, spherical shape and difference of microstructure, and to further highlight the cores, some cores are circled in the SEM micrographs. As can be seen, many of the particles include multiple cores.

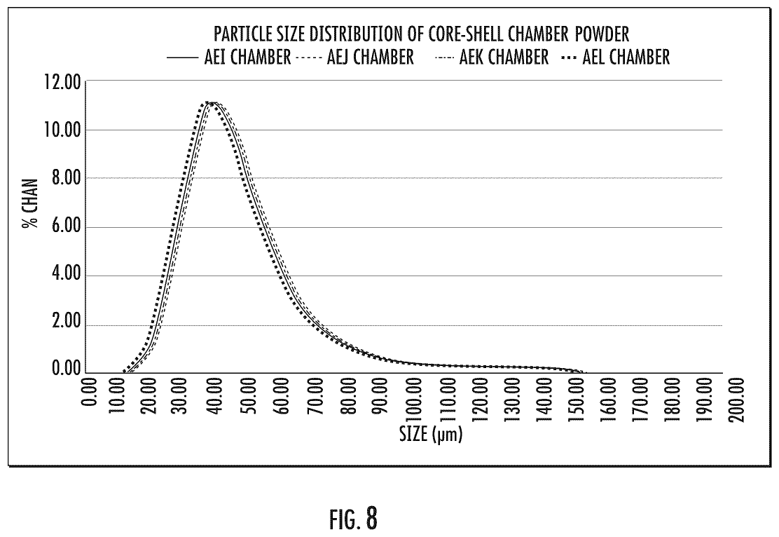

FIG. 8 is a graph of the particle size distribution for the core/shell ceramic particles AEI, AEJ, AEK, and AEL. As can be seen, the particle size distribution for each of the core/shell ceramic particles was substantially uniform, and the median particle size was around 40 μm for each of the core/shell combinations.

The core/shell ceramic particles AEI, AEJ, AEK, and AEL at both calcining temperatures were batched into a green paste for extrusion. Each core/shell ceramic particle combination was combined with a pore former, an inorganic binder, and an organic binder. The composition of the reactive inorganic binder (MX) is given in Table 6, below. The MX inorganic binder was a cyclone spraydried powder containing six inorganic components of hydrous and calcined varieties and a low level of sodium, which allows for earlier sintering than pure cordierite precursor mixtures.

TABLE 6
Composition of Inorganic Binder

| Material Name | MX |
|---|---|
| % Cordierite/% Mullite | 100/0 |
| Alumina (Almatis A152SG) | 14.55 |
| Montana Talc | 40.2 |
| FHC Hydrous Clay | 11.58 |
| Hydral 710 Hydrated Alumina | 18.42 |
| Silica Soot | 14.25 |
| Liga Sodium Stearate | 1 |
| Duramax B1022 | 2 |
| Duramax D3005 | 0.2 |
| Water (wt %) | 13.0 |
| Solids Loading (vol %) | 20 |
| pH | 9.85 |
| Viscosity (mPas) | 36 |

The core/shell ceramic particles were combined with the binders and pore formers according to the mixtures shown below in Table 7. In each case, the inorganic particles comprised 85 wt % of the core/shell ceramic particles and 15 wt % of the inorganic binder.

TABLE 7
Composition of Extrusion Batches to form Honeycomb Structure

| | UOP | | UOQ | | UOR | | UOS | |
|---|---|---|---|---|---|---|---|---|
| Ingredient | wt % | grams | wt % | grams | wt % | grams | wt % | grams |
| AEI (1325° C./4 h) | 85 | 680 | | | | | | |
| AEI (1380° C./8 h) | | | 85 | 680 | | | | |
| AEJ (1350° C./4 h) | | | | | 85 | 680 | | |
| AEJ (1380° C./8 h) | | | | | | | 85 | 680 |

Inorganic Binder

| | | | | | | | | |
|---|---|---|---|---|---|---|---|---|
| MX | 15 | 120 | 15 | 120 | 15 | 120 | 15 | 120 |

Pore Former

| | | | | | | | | |
|---|---|---|---|---|---|---|---|---|
| VH XL Pea Starch | 15 | 120 | 15 | 120 | 15 | 120 | 15 | 120 |
| Graphite Synthetic | 10 | 80 | 10 | 80 | 10 | 80 | 10 | 80 |
| 4565 | | | | | | | | |

Organic Binder

| | | | | | | | | |
|---|---|---|---|---|---|---|---|---|
| MM3 - Hydroxypropyl | 9 | 90 | 9 | 90 | 9 | 90 | 9 | 90 |
| methylcellulose F240 | | | | | | | | |
| LF | | | | | | | | |
| Na-stearate Liga SG3 | 1.4 | 14 | 1.4 | 14 | 1.4 | 14 | 1.4 | 14 |

Other Liquid

| MOX30A | 4.13 | 41.3 | 4.13 | 41.3 | 4.13 | 41.3 | 4.13 | 41.3 |
|---|---|---|---|---|---|---|---|---|
| Water | 55 | 550 | 50 | 500 | 51 | 510 | 53 | 525 |
| | UOT | | UOU | | UOV | | UOW | |
| Ingredient | wt % | grams | wt % | grams | wt % | grams | wt % | grams |
| AEK (1275° C./8 h) | 85 | 629 | | | | | | |
| AEK (1380° C./8 h) | | | 85 | 680 | | | | |
| AEL (1275° C./8 h) | | | | | 85 | 680 | | |
| AEL (1380° C./8 h) | | | | | | | 85 | 680 |

Inorganic Binder

| | | | | | | | | |
|---|---|---|---|---|---|---|---|---|
| MX | 15 | 111 | 15 | 120 | 15 | 120 | 15 | 120 |

Pore Former

| | | | | | | | | |
|---|---|---|---|---|---|---|---|---|
| VH XL Pea Starch | 15 | 111 | 15 | 120 | 15 | 120 | 15 | 120 |
| Graphite Synthetic | 10 | 74 | 10 | 80 | 10 | 80 | 10 | 80 |
| 4565 | | | | | | | | |

Organic Binder

| | | | | | | | | |
|---|---|---|---|---|---|---|---|---|
| MM3 - Hydroxypropyl | 9 | 83.25 | 9 | 90 | 9 | 90 | 9 | 90 |
| methylcellulose F240 | | | | | | | | |
| LF | | | | | | | | |
| Na-stearate Liga SG3 | 1.4 | 12.95 | 1.4 | 14 | 1.4 | 14 | 1.4 | 14 |

Other Liquid

| | | | | | | | | |
|---|---|---|---|---|---|---|---|---|
| MOX30A | 4.13 | 41.3 | 4.13 | 41.3 | 4.13 | 41.3 | 4.13 | 41.3 |
| Water | 55 | 545 | 50 | 500 | 52 | 515 | 50 | 500 |

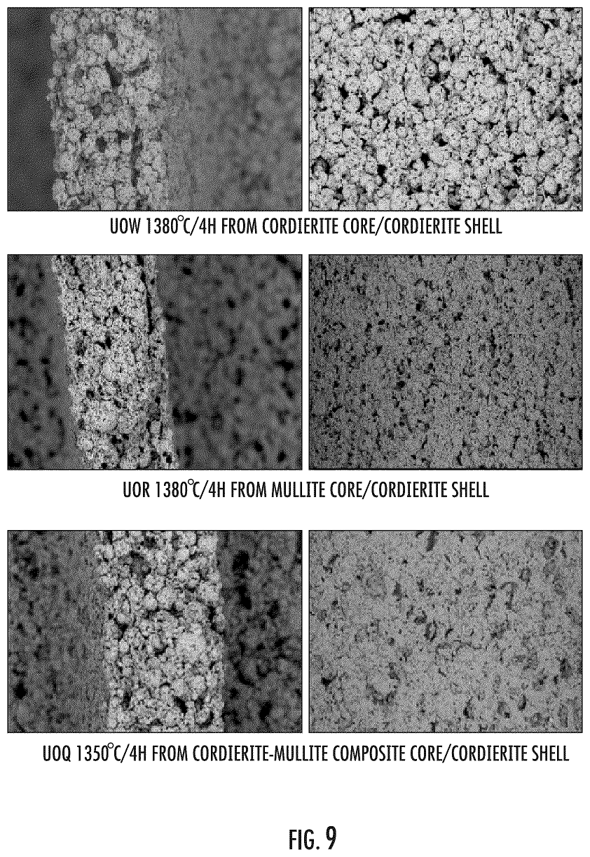

The batches were prepared according to Table 7 and extruded with a 1″ ram (300/8) to form honeycomb structures. FIG. 9 provides SEM on-wall views and views of fractured wall sections for various 1″ fired honeycomb structures to illustrate the particle structures and the distribution of porosity across the honeycomb structure. From the images, it can be seen that the inorganic spraydried green binder (MX) from the extrusion batch has reacted and formed interlinks between the extruded ceramic particles. For cordierite core, cordierite shell ceramic particles, the links are fine and the particles are well separated. The wall surface shows for those compositions a clean particle arrangement. For materials with mullite-containing cores, inorganic binder has segregated during extrusion to the wall surfaces and formed there a wall surface membrane. As a result, the particle structure is less visible at the wall surface than for pure cordierite materials. It was found that in case of pure cordierite prereacted particles, no membrane-like surface layer formed. For cordierite/mullite composite or mullite cores, a discontinuous membrane-like surface layer formed on the wall surfaces from the inorganic binder with a characteristic pore size around 1 μm.

Table 8 provides the properties of the extruded honeycomb structures obtained from different ceramic particle compositions and from different honeycomb firing temperatures. In particular, the properties include porosity characteristics, coefficient of thermal expansion (CTE), and honeycomb strength.

TABLE 8
Properties of Extruded Honeycomb Structures

| | Firing | Firing | | | Interparticle | Interparticle |
|---|---|---|---|---|---|---|
| | Temp | Time | Porosity | D50 | Porosity | D50 |
| Honeycomb | (° C.) | (h) | (%) | (μm) | (%) | (μm) |
| UOP | 1350 | 4 | 64.00 | 4.80 | 36.21 | 8.42 |
| UOP | 1380 | 4 | 59.92 | 5.59 | 35.59 | 8.43 |
| UOQ | 1350 | 4 | 65.37 | 6.96 | 45.36 | 9.53 |
| UOQ | 1380 | 4 | 60.77 | 7.45 | 42.79 | 9.05 |
| UOR | 1400 | 4 | 44.36 | 5.39 | 28.10 | 6.35 |
| UOR | 1380 | 4 | 61.15 | 4.70 | 33.67 | 7.55 |
| UOS | 1400 | 4 | 42.91 | 5.67 | 28.75 | 6.35 |
| UOS | 1380 | 4 | 62.77 | 5.19 | 37.65 | 7.55 |
| UOT | 1300 | 4 | 67.07 | 9.94 | 52.88 | 12.05 |
| UOT | 1380 | 4 | 63.74 | 7.43 | 44.25 | 9.64 |
| UOU | 1300 | 4 | 65.96 | 7.19 | 47.95 | 9.53 |
| UOU | 1380 | 4 | 63.60 | 8.34 | 48.10 | 9.89 |
| UOV | 1300 | 4 | 65.75 | 6.19 | 41.87 | 8.25 |
| UOV | 1380 | 4 | 59.84 | 6.39 | 39.45 | 8.43 |
| UOW | 1300 | 4 | 69.40 | 5.66 | 43.83 | 9.78 |
| UOW | 1380 | 4 | 61.00 | 9.19 | 48.43 | 10.95 |

| | Particle | Particle | | |
|---|---|---|---|---|
| | Porosity | Pore Size | CTE | MOR |
| Honeycomb | (%) | (μm) | (10⁻⁷/K) | (psi) |
| UOP | 43.6 | 2.5 | 25.3 | 185 |
| UOP | 37.8 | 2.4 | 25.4 | 367 |
| UOQ | 36.6 | 2.5 | 25.8 | 136 |
| UOQ | 31.4 | 3.7 | 26.1 | 292 |
| UOR | 22.6 | 1.8 | 31.4 | 1127 |
| UOR | 41.4 | 1.8 | 30.6 | 432 |
| UOS | 19.9 | 1.8 | 31.7 | 783 |
| UOS | 40.3 | 2.6 | 30.8 | 286 |
| UOT | 30.1 | 2.2 | 18.6 | 157 |
| UOT | 34.9 | 2.9 | 17.8 | 268 |
| UOU | 34.6 | 4.3 | 17.2 | 117 |
| UOU | 29.9 | 4.5 | 17.5 | 263 |
| UOV | 41.1 | 2.9 | 18.2 | 233 |
| UOV | 33.7 | 2.8 | 16.9 | 370 |
| UOW | 45.5 | 3.2 | 16.3 | 86 |
| UOW | 24.4 | 2.5 | 16.8 | 207 |

From Table 8, it can be noted that 1400° C. is too high of a firing temperature because this temperature is associated with a significant loss in porosity. All other firing temperatures produced a porosity of about 60% or higher with median pore sizes (D50) in a range of 5 μm to 10 μm. CTE for the pure cordierite materials is between 16 and 19·10⁻⁷/K over the temperature range of room temperature to 800° C. The value is close to that of honeycomb made form single phase particles but slightly higher. The domain size for cordierite in core/shell particles is further reduced form the full particle size to a partial particle size. CTE for materials from particles with mullite/cordierite composite or mullite core are higher, 25-26·10⁻⁷/K and 30-32·10⁻⁷/K, respectively.

As expected, the modulus of rupture (MOR) for the materials fired at temperatures as low as 1300° C. was low. However, firing temperatures of 1350° C. and 1380° C. produced an exceptionally high modulus of rupture of up to 260 to 300 psi for pure cordierite materials or even 370 to 432 psi for materials from mullite-containing core in cordierite shell. These values exceed significantly the strength of materials made from normal cordierite or mullite particles and also exceeds the strength of materials made from a reactive batch.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A sintered ceramic article, comprising:
sintered ceramic particles, the sintered ceramic particles comprising a shell at least partially surrounding at least one core;
wherein the at least one core comprises a first ceramic phase and the shell comprises a second ceramic phase;
wherein the first ceramic phase differs from the second ceramic phase in at least one of density, composition, or pore morphology.

2. The sintered ceramic article of claim 1, wherein the first ceramic phase is denser than the second ceramic phase.

3. The sintered ceramic article of claim 1, wherein the second ceramic phase comprises open and interconnected pores.

4. The sintered ceramic article of claim 1, wherein the first ceramic phase comprises open and interconnected pores.

5. The sintered ceramic article of claim 1, wherein the first ceramic phase is a different composition than the second ceramic phase.

6. The sintered ceramic article of claim 1, wherein the first ceramic phase and the second ceramic phase are selected from a group consisting of cordierite, mullite, alumina, aluminum titanate, feldspar, and combinations thereof.

7. The sintered ceramic article of claim 1, wherein the sintered ceramic particles comprise pores having a median pore size of up to 5 μm.

8. The sintered ceramic article of claim 1, wherein the sintered ceramic article comprises a porosity of at least 40%.

9. The sintered ceramic article of claim 1, wherein the sintered ceramic article comprises a median pore size of 1 μm to 10 μm.

10. The sintered ceramic article of claim 1, wherein the sintered ceramic article comprises a coefficient of thermal expansion in a range from 10·10⁻⁷/K to 40·10⁻⁷/K.

11. The sintered ceramic article of claim 1, wherein the sintered ceramic article comprises a modulus of rupture of at least 250 psi.

12. The sintered ceramic article of claim 1, further comprising a washcoating of a catalyst on the sintered ceramic particles.

13. The sintered ceramic article of claim 1, wherein the second ceramic phase comprises a getter of a carbon-containing gas.

14. The sintered ceramic article of claim 1, wherein a ratio of shell to at least one core is in a range from 0.5:1 to 2:1.

15. The sintered ceramic article of claim 1, wherein the sintered ceramic article is a honeycomb structure.

16. A method, comprising:
extruding a paste comprising ceramic particles to form a green structure, the ceramic particles comprising a shell at least partially surrounding at least one core, wherein the at least one core comprises a first ceramic phase and the shell comprises a second ceramic phase, and wherein the first ceramic phase differs from the second ceramic phase in at least one of density, composition, or pore morphology;
firing the green structure to sinter the ceramic particles into a sintered ceramic article.

17. The method of claim 16, wherein the paste further comprises a binder, a pore former, and a liquid carrier, and wherein, prior to extruding, the method further comprises:
forming a first slurry of a first composition configured to form the first ceramic phase;
spraydrying the first slurry to form core particles of the first ceramic phase; and
calcining the core particles.

18. The method of claim 17, further comprising:
forming a second slurry of a second composition configured to form the second ceramic phase;
spraydrying the second slurry with the core particles to form the ceramic particles with shells at least partially around the at least one core; and
calcining the ceramic particles.

19. The method of claim 16, wherein one or more of:
the first ceramic phase is denser than the second ceramic phase,
the second ceramic phase comprises open and interconnected pores,
the first ceramic phase comprises open and interconnected pores,
the first ceramic phase is a different composition than the second ceramic phase, and
the first ceramic phase and the second ceramic phase are selected from a group consisting of cordierite, mullite, alumina, aluminum titanate, feldspar, and combinations thereof.

20. The method of claim 16, wherein 10% of the ceramic particles have a particle size below a first size (D10), wherein 50% of the ceramic particles have a particle size below a second size (D50), wherein 90% of the ceramic particles have a particle size below a third size (D90), and wherein the particle size has a span (D90−D10/D50) in a range from 0.8 to 1.4.
